(19) United States
(12) Patent Application Publication
(10) Pub. No.: US 2012/0223845 A1
(43) Pub. Date: Sep. 6, 2012

(54) MOTOR VEHICLE

(75) Inventor: Toralf Schumann, Neuhaus (DE)

(73) Assignee: Audi AG, Ingolstadt (DE)

(21) Appl. No.: 13/409,830

(22) Filed: Mar. 1, 2012

(30) Foreign Application Priority Data
Mar. 2, 2011 (DE) 10 2011 012 791.7

(51) Int. Cl. G08G 1/137

(52) U.S. Cl. 340/995.19

(57) ABSTRACT

A motor vehicle includes a detection device for detecting a route actually traveled by the motor vehicle and the actual position of the motor vehicle on the route, a storage device with route-specific traffic sign information, and a control device with a display for outputting route-specific traffic sign information. The route-specific traffic sign information includes first information relating to at least one traffic sign ahead of the actual position of the motor vehicle on the route and second information representing a measure for the distance between the traffic signal ahead and the actual position of the motor vehicle.

### CROSS-REFERENCES TO RELATED APPLICATIONS

This application claims the priority of German Patent Application, Serial No. 10 2011 012 791.7, filed Mar. 2, 2011, pursuant to 35 U.S.C. 119(a)-(d), the content of which is incorporated herein by reference in its entirety as if fully set forth herein.

### BACKGROUND OF THE INVENTION

The present invention relates to a motor vehicle, with at least one detection device for detecting the route actually traveled by the motor vehicle and the actual position of the motor vehicle on the route, at least one storage device comprising route-specific traffic sign information, and at least one control device configured to output at least one route-specific traffic sign information.

The following discussion of related art is provided to assist the reader in understanding the advantages of the invention, and is not to be construed as an admission that this related art is prior art to this invention.

Modern motor vehicles are typically equipped with a driver assist system, for example a navigation device, which provides a driver with traffic guidance to a destination defined by the driver. Route-specific information taken into account by the driver assist system includes, in particular, also traffic signs, i.e. road signs, which can be outputted via output means when the respective route segment where the traffic sign is located has been reached. The required traffic sign information relating to the traffic signs is typically stored in a storage device or is measured with a traffic sign detection device and supplied to the control device to be outputted via an output means.

Disadvantageously, the driver receives relevant information only after arriving at the route segment where the traffic sign is actually located, so that the driver receives, for example, a corresponding message when actually reaching, for example, a route segment with a reduced speed limit, forcing the driver to quickly respond and/or reduce the speed of the motor vehicle. However, in this makes anticipatory, fuel saving driving more difficult and may even increase the risk of a collision, in particular when the driver abruptly alters the speed of the motor vehicle, i.e., abruptly decelerates the motor vehicle.

It would therefore be desirable and advantageous to obviate prior art shortcomings and to provide an improved motor vehicle with anticipatory driving.

### SUMMARY OF THE INVENTION

According to one aspect of the present invention, a motor vehicle includes at least one detection device configured to detect an actual route traveled by the motor vehicle and an actual position of the motor vehicle on the route, at least one storage device with route-specific traffic sign information, and at least one control device controlling output means, with the output means outputting at least one route-specific traffic sign information. The at least one route-specific traffic sign information includes at least one first information relating to at least one traffic sign ahead of the actual position of the motor vehicle on the route, and at least one second information representing a measure for a distance between the traffic signal ahead and the actual position of the motor vehicle.

The motor vehicle according to the invention may thus provide the driver, when outputting the at least one route-specific traffic sign information, not only with an indication of the actual traffic sign(s) ahead on the route traveled by the motor vehicle in form of the first information, but also, in form of the second information, with a qualitative and/or quantitative indication about the distance the traffic sign(s) ahead in relation to the actual position of the motor vehicle. The driver is thus fully informed about all traffic sign information on the route ahead and can adapt his driving early on to a changing traffic situation.

According to an advantageous feature of the present invention, the control device may output the at least one route-specific traffic sign information only for the next traffic sign immediately ahead. However, corresponding route-specific traffic sign information may advantageously also be outputted for a plurality of traffic signs ahead.

The term “traffic sign” used within the context of the invention includes basically all conventional traffic signs. For example, the traffic sign ahead may be, for example, a mandatory sign and/or a prohibition sign and/or a danger sign and/or a speed limit. Accordingly, the driver is then informed within the context of the first information about the relevance and/or quality of the change of the route ahead or of the traffic ahead indicated by the traffic sign ahead.

According to an advantageous feature of the present invention, if the at least one route-specific traffic sign information indicates that a speed limit is 300 m ahead, i.e. the first information indicates the speed limit and the second information a measure for the distance of 300 m of the speed limit ahead from the actual position of the motor vehicle, then the driver knows early on that he most likely will need to reduce the actual speed and is made aware of the time and distance remaining to the impending speed limit as a function of the actual position of the motor vehicle.

According to another advantageous feature of the present invention, the at least one route-specific traffic sign information may indicate, for example, a passing ban 1 km ahead, i.e. the first information then indicates the passing ban and the second information a measure for the a distance of 1 km of the passing ban ahead from the actual position of the motor vehicle. The driver is thus informed early on that he should if possible soon pass other road users on the route within the next kilometer, such as other vehicles or the like, that can be passed safely.

According to yet another advantageous feature of the present invention, the at least one route-specific traffic sign information may indicate, for example, that a bridge will be crossed in 500 m, across which only vehicles having an actual weight, including load, not exceeding 5.5 t are allowed to drive, i.e. the first information indicates a prohibition sign for vehicles having a weight that exceeds including load the actual limit of 5.5 t, and the second information indicates a measure for the distance of 500 m of the prohibition sign ahead from the actual position of the motor vehicle.

According to an advantageous feature of the present invention, the driver of a motor vehicle, here a passenger car, may notice based on the output of the at least one route-specific traffic sign information that this information is not relevant; however, the at least one route-specific traffic sign information may indeed be relevant for the driver of a truck which is also included in the definition of the motor vehicle according to the invention.

According to an advantageous feature of the present invention, the control device may consider at least one boundary condition when detecting the at least one route-specific traffic sign information. The boundary condition may include, for example, actual driving state information relating to the actual driving state of the motor vehicle, for example the actual speed of the motor vehicle and/or other vehicle information, such as dimensions, weight, etc. of the vehicle, so that traffic sign information that is not relevant for the actual driving state of the motor vehicle or other vehicle information may be filtered and/or not outputted. For example, when the driver drives at a moderate pace, for example below a speed limit ahead, corresponding traffic sign information may not be outputted or, as discussed in the previous example, traffic sign information relating to height, weight, axle loads, etc. for a specific road section ahead which are generally irrelevant for the driver of a passenger car will not be outputted.

According to another advantageous feature of the present invention, when taking into account the at least one boundary condition, such as in particular actual driving state information relating to the actual driving state of the motor vehicle, such as the actual vehicle speed and/or other vehicle information, such as dimensions, weight, etc. of the vehicle, the at least one route-specific traffic sign information, i.e. in particular of the second information representing a measure for the distance of the traffic sign ahead from the actual position of the motor vehicle, may be outputted in adapted form; for example, the at least one route-specific traffic sign information may be outputted earlier or with a different intensity when driving at a high speed, and/or the second information may span another corridor before reaching the corresponding speed limit.

According to an advantageous feature of the present invention, the second information representing a measure for the distance of the traffic signal ahead from the actual position of the motor vehicle may include at least one distance value or distance, and/or at least one time value, for example a time duration, before reaching the at least one traffic sign. The driver can then adapt his driving based on the, in particular, qualitatively or quantitatively outputted distance value, for example, the distance between his actual position relative to the traffic sign ahead. A driver may also estimate the time until the respective traffic sign is reached or the time of day when the respective traffic sign may be reached.

According to another advantageous feature of the present invention, the second information, i.e. the distance value and the time value, may be dynamically adapted to the distance relative to the respective traffic sign which changes during the travel of the motor vehicle. The second information may then be outputted several times depending on the change in distance of the motor vehicle from the traffic sign ahead. However, the second information may also be outputted only once.

According to an advantageous feature of the present invention, the first and/or second information may be outputted optically and/or acoustically. A driver may then be informed both optically via a corresponding display means, such as a display and the like, or acoustically via a corresponding loudspeaker device and the like, about the at least one route-specific traffic sign information.

According to another advantageous feature of the present invention, the first information which can be or is outputted optically may be a graphic representation of the traffic sign ahead and/or text information corresponding to the traffic sign ahead. Accordingly, for example a graphic image which is a true reproduction of the traffic sign ahead, or alternatively or in addition, text information corresponding to the traffic sign ahead, for example “permissible maximum speed 120 km/h”, “general passing ban” and the like, may be outputted.

According to an advantageous feature of the present invention, the second information which can be or is outputted optically, may be corresponding text information or a bar graph corresponding to the information representing a measure for the distance of the traffic sign ahead from the actual position of the motor vehicle. Advantageously, the text information may be a static or dynamic distance and/or time value; the bar graph may display different colors, fill and the like depending on the different distances of the motor vehicle from the traffic sign ahead. However, other graphic representations of geometric forms different from a bar graph, for example circles, triangles, etc. may also be contemplated.

According to an advantageous feature of the present invention, the route-specific traffic sign information additionally may include at least one third actual driving state information relating to the actual driving state of the motor vehicle and/or at least one warning information evaluating vehicle information of the motor vehicle relating to the content of the at least one traffic sign ahead. The warning information indicates to the driver a certain urgency, in particular in situations where a change in the driving commensurate with the content of the traffic sign ahead requires a significant intervention in the actual driving state of the motor vehicle. For example, if a speed limit of 80 km/h lies ahead in 500 m, while the driver still drives at a speed above 200 km/h, then the driver can be unmistakably informed of the impending requirement to reduce the speed by the warning information, which can be outputted optically and/or acoustically, i.e. in particular via corresponding graphic symbols, text information and/or warning sounds. This approach may also be useful, for example, when a planned exit from a freeway is approached at an excessive speed or in an impending passage through a village, because the driver receives hereby specific information that his driving does not actually correspond to the route segment ahead.

According to an advantageous feature of the present invention, the output of the first and/or second information may be configurable by the operator. For example, an operator or driver may select ahead of time which traffic signs should even be considered by the control device and outputted with together with the at least one route-specific traffic sign information, by outputting for example danger signs ahead which directly relate to the driving and/or speed limits, but not regulation signs, such as no standing and no parking signs. It will be understood that with the operator-enabled configuration, output of the first and/or second information may also be turned on or turned off.

According to another advantageous feature of the present invention, additionally to the at least one route-specific traffic sign information, at least one information representing an actual traffic sign associated with the actual position of the motor vehicle on the route may be outputted. The driver is then informed about prevailing traffic sign information for the actually traveled route segment and about the traffic sign information ahead to the route segment ahead, and receives a comprehensive overview of the route to be traveled by the driver.

According to an advantageous feature of the present invention, the detection device, the storage device and the control device may be associated with a navigation device installed in or on the motor vehicle, wherein when traffic guidance is activated, the at least one route-specific traffic sign information relates to the route which forms the basis for the activated traffic guidance, and when traffic guidance is not activated, the at least one route-specific traffic sign information relates to relates to a route which is traveled by the motor vehicle with a high probability, or to specific route segments that can be or are predetermined, in particular in a predeterminable or predetermined area before possibilities ahead for exiting a freeway. In the first situation, only the traffic signs ahead that are relevant for the selected route under traffic guidance may be taken into consideration and the corresponding traffic sign information is outputted. Alternatively, i.e. when traffic guidance is not activated, a route traveled with a high probability by the motor vehicle or predeterminable or predetermined specific route segments may be used, and corresponding traffic signs ahead may be taken into account when outputting the at least one traffic sign information. The route traveled by the motor vehicle with a high probability can be determined and/or computed by using conventional navigation devices and will therefore not be described further here. The predeterminable or predetermined specific route segments, for example predeterminable or predetermined sections ahead of an exit from a freeway, may be defined at the factory or by the operator, so that the control device can be programmed to output the at least one traffic sign information for route segments of a route selected by the operator.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic diagram of a motor vehicle according to the present invention,

FIG. 2 is a schematic diagram of route-specific traffic sign information according to the present invention according to a first embodiment,

FIG. 3 is a schematic diagram of route-specific traffic sign information according to the present invention according to a second embodiment,

FIG. 4 is a schematic diagram of route-specific traffic sign information according to the present invention according to a third embodiment, and

FIG. 5 is a schematic diagram of route-specific traffic sign information according to the present invention according to a fourth embodiment.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

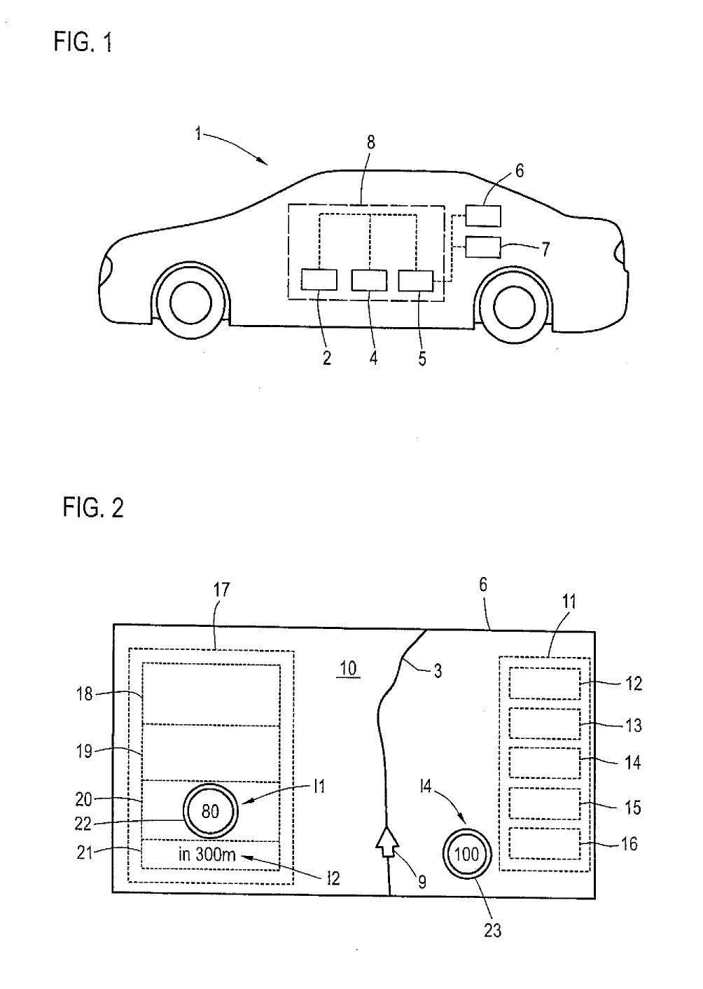

Turning now to the drawing, and in particular to FIG. 1, there is shown a schematic diagram of a motor vehicle 1 according to the invention. The motor vehicle 1 includes a detection device 2 for detecting the route 3 (see FIG. 2) actually traveled by the motor vehicle 1 and the actual position of the motor vehicle 1 on the route 3, a storage device 4 in form of a database containing route-specific traffic sign information, and a control device 5 for outputting at least one route-specific traffic sign information via output means in form of a display 6 and/or a loudspeaker device 7. As illustrated, the detection device 2, the storage device 4 and the control device 5 communicate via communication lines that are part of a vehicle network. As indicated by the dashed frame surrounding the detection device 2, the storage device 4 and the control device 5, these devices may be components of a navigation device 8 installed in or on the vehicle.

As illustrated in FIG. 2, the actual position of the motor vehicle 1 is outputted on the display 6 in a conventional manner through a graphic symbol, such as the arrow 9, on the route 3 during the operation of the motor vehicle, i.e. while the motor vehicle travels along a route 3, for example a freeway, a country road, a road within a village, etc. The motor vehicle 1 indicated by the arrow 9 moves hereby in a graphic environment 10 representing an image of a two-dimensional or three-dimensional map.

In an exemplary display bar 11, optionally relevant information, such as a compass (box 12), a scaled map representation of the environment 10 (box 13), with activated traffic guidance of the navigation device 8 the distance to be traveled to the destination (box 14), the expected remaining time until the destination is reached (box 15) and altitude information (box 16) may be outputted during the trip. In an exemplary additional display bar 17, information about a parking area ahead (box 18), a fork to a new road or street (box 19) determined with traffic guidance can also be outputted.

The at least one traffic sign information according to the invention is displayed in the boxes 20, 21, wherein a first information I1 relating to at least one traffic sign ahead in relation to the actual position of the motor vehicle 1 on the route 3 can be or is outputted inside the box 20, and a second information 12 representing a measure for the distance of the traffic sign 22 ahead from the actual position from the motor vehicle can be or is outputted inside the box 21. The traffic sign 22 ahead may be any traffic sign, wherein merely as an example a speed limit of 80 km/h is shown.

As can be seen, the first information I1 is provided as a graphic representation of a speed limit of 80 km/h ahead, and the second information 12 is provided as text information “in 300 m”, describing a distance value of the actual position of the motor vehicle 1 from the traffic sign 22 ahead. Likewise, the second information I2 may also describe a time value, in particular the elapsed time until the traffic sign 22 ahead is reached, for example “in 2 minutes.” The second information I2 may advantageously be outputted several times depending on the changing distance of the motor vehicle 1 from the traffic sign 22 ahead, i.e. the second information I2 may be outputted dynamically adapted to the actual distance between the motor vehicle 1 and to the traffic sign 22 ahead.

In addition to the second information I2 in form of pure text information, the second information I2 may alternatively or in addition also be outputted as a graphic representation, for example in form of a bar graph (not shown), wherein the bar is filled more or less depending on the actual position of the motor vehicle 1 relative to the traffic sign 22 ahead.

Alternatively or in addition, the first and/or second information I1, I2 may also be outputted acoustically by the loudspeaker device 7.

The combined representation of both the type in the content of the traffic sign 22 directly ahead in form of the first information I1 as well as the distance and/or time until the traffic sign 22 is reached in form of the second information I2 facilitates anticipatory and hence fuel-saving economic driving, because the driver is informed early on about traffic changes corresponding to the particular content of the at least one traffic sign 22 ahead.

In addition to the aforementioned representations, information I4 representing an actual traffic sign 23 relating to the actual position of the motor vehicle 1 on the route 3 may be outputted on the display 6.

The present description is based on the assumption that the traffic guidance of the navigation device 8 is activated, with the route-specific traffic information according to the invention, i.e. the first information I1 and the second information I2, relating to the route 3 on which the activated traffic guidance is based. If traffic guidance is not activated, then the route-specific traffic sign information according to the invention, i.e. the first information I1 and/or the second information I2, relates to a route 3 that is determined by the control device 5 and the motor vehicle 1 will be travel with high probability. Likewise, the route-specific traffic sign information may be outputted at specified predeterminable or predetermined route segments, for example in a predeterminable or predetermined area before a possible exit ahead from a freeway.

Within the context of the illustration in FIG. 2, the term “box” does not necessarily refer only to an actual graphic box on the display 6; the boxes are therefore shown with dotted lines and are to be understood essentially as placeholders where the information can be displayed or outputted.

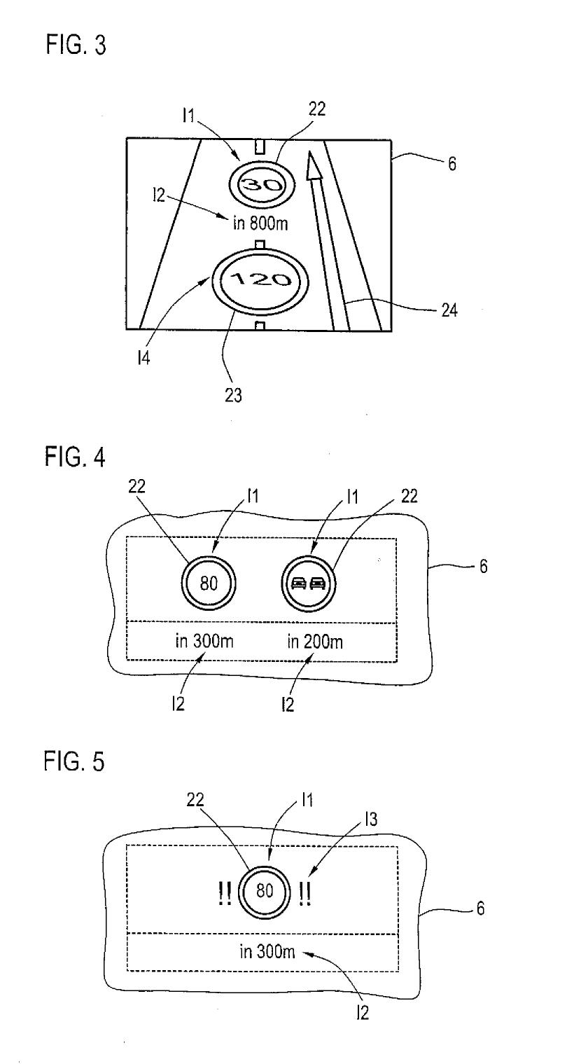

FIG. 3 shows a schematic diagram of a second embodiment of route-specific traffic sign information according to the invention. This embodiment differs from the embodiment illustrated in FIG. 2 essentially by the graphic arrangement of the first and second information I1, I2 forming the road-specific traffic sign information, which are displayed directly on the illustrated route 3. In addition, an information I4 showing an actual traffic sign 23 relating to the actual position of the motor vehicle on the route 3 is outputted, wherein the information I4 is in the diagram of FIG. 3 arranged in front of the road-specific traffic sign information according to the invention, so that the driver can easily recognize that the current speed limit is 120 km/h and that a speed limit of 30 km/h will be in effect in 800 m, allowing the driver to reduce the speed in anticipation of the lower speed limit. The route of the motor vehicle 1 with active traffic guidance by the navigation device 8 is shown in form of the arrow 24. The representation according to FIG. 3 is particularly suited for a so-called “cluster instrument display” or a so-called head-up display.

FIG. 4 shows schematic diagrams of two traffic sign information items according to the invention. Within the context of the invention, several route-specific traffic sign information items can be outputted, as indicated in FIG. 4 by the speed limit of 80 km/h to be in effect in 300 m and a general passing ban in 200 m, each relative to the current position of the motor vehicle 1. The relevant current traffic sign information, i.e. the traffic sign information ahead next, can be depicted in color or highlighted for improved visibility, whereas traffic sign information that is farther away from the motor vehicle 1 at a specified time may be illustrated with gray background. The driver can then easily distinguish which traffic sign information and associated change in the driving is more imminent.

FIG. 5 shows a schematic diagram of a fourth exemplary embodiment of route-specific traffic sign information according to the invention. As an important difference to the previous exemplary embodiments, additionally a third actual driving state information relating to the actual driving state of the motor vehicle 1 and/or at least one warning information I3 assessing vehicle information of the motor vehicle 1 with respect to the content of the at least one traffic sign 22 ahead is shown in form of an exclamation mark. A driver can then be warned to quickly and urgently change his driving commensurate with the traffic sign 22 ahead. In particular, in the present example, the actual vehicle speed is compared with the speed limit commensurate with the traffic sign 22 ahead and the speed limit ahead may be emphasized more strongly by a changing number of symbols, such as the previously mentioned exclamation mark, considering the remaining distance, which is represented by the second information I2. This may optionally be augmented by outputting an acoustic warning sound which may be changeable.

When determining and outputting the route-specific traffic sign information, certain boundary conditions, for example actual driving state information relating to the actual driving state of the motor vehicle, such as the actual vehicle speed, and/or other vehicle information, such as vehicle dimensions, vehicle weight, etc., may be considered, so that the at least one route-specific information, i.e. in particular the second information representing a measure for the distance of the traffic sign ahead from the actual position of the motor vehicle, may be outputted adaptively. Likewise, when traveling at high speed, the at least one route-specific traffic sign information may be outputted earlier, and/or the second information may span an additional corridor until the corresponding speed limit is reached.

Fundamentally, the output of the first and search or second information I1, I2 can be configured by an operator. An operator can then specify which type of traffic sign 22 should be considered when determining and outputting the at least one route-specific traffic sign information, so that for example only traffic signs relevant for passenger cars are considered and outputted. The route segment ahead of the motor vehicle 1 taken into consideration by the control device 5 when determining the at least one route-related traffic sign information can be adjusted, so that traffic signs 22 located at any distance ahead can be displayed to a driver, as well as the distance and/or the elapsed time until the motor vehicle 1 reaches these traffic signs 22.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A motor vehicle, comprising:
at least one detection device configured to detect an actual route traveled by the motor vehicle and an actual position of the motor vehicle on the route,
at least one storage device comprising route-specific traffic sign information, and
at least one control device controlling output means, said output means outputting at least one route-specific traffic sign information,
wherein the at least one route-specific traffic sign information comprises at least one first information relating to at least one traffic sign ahead of the actual position of the motor vehicle on the route, and at least one second information representing a measure for a distance between the traffic signal ahead and the actual position of the motor vehicle.

2. The motor vehicle of claim 1, wherein the second information comprises at least one distance value representing a measure for the distance between the traffic signal ahead and the actual position of the motor vehicle, or at least one time value before the motor vehicle reaches the at least one traffic sign ahead.

3. The motor vehicle of claim 1, wherein ay least one of the first information and the second information is outputted optically or acoustically, or both.

4. The motor vehicle of claim 1, wherein the first information is outputted optically as a graphic representation of the traffic sign ahead or as text information corresponding to the traffic sign ahead, or both.

5. The motor vehicle of claim 3, wherein the second information is outputted optically as text information or as a bar graph corresponding to the second information which represents a measure for the distance of the traffic sign ahead from the actual position of the motor vehicle.

6. The motor vehicle of claim 1, wherein the second information is outputted once or multiple times depending on a changing distance of the motor vehicle from the traffic sign ahead.

7. The motor vehicle of claim 1, wherein the traffic sign is selected from the group consisting of a mandatory sign, a prohibition sign, a danger sign and a speed limit.

8. The motor vehicle of claim 1, wherein the route-specific traffic sign information additionally comprises at least one third actual driving state information relating to an actual driving state of the motor vehicle or at least one warning information obtained by evaluating vehicle information of the motor vehicle relating to the content of the at least one traffic sign ahead.

9. The motor vehicle of claim 3, wherein the output of at least one of the first and second information is configured by an operator.

10. The motor vehicle of claim 1, wherein additionally to the at least one route-specific traffic sign information, at least one information representing an actual traffic sign associated with the actual position of the motor vehicle on the route is outputted.

11. The motor vehicle of claim 1, further comprising a navigation device installed in or on the motor vehicle, said navigation device operatively connected with the detection device, the storage device and the control device and providing traffic guidance, wherein when the traffic guidance is activated, the at least one route-specific traffic sign information relates to a route which forms a basis for the activated traffic guidance, and when the traffic guidance is not activated, the at least one route-specific traffic sign information relates to a route which is traveled by the motor vehicle with a high probability, or to specific predetermined route segments.
